(19) United States
(12) Patent Application Publication
(10) Pub. No.: US 2017/0188621 A1
(43) Pub. Date: Jul. 6, 2017

(54) Device and Method For the Controlled Delivery of a Single Service Portion of a Butter Flavored Topping

(71) Applicant: Eric Evan Etter, Cordova, TN (US)

(72) Inventor: Eric Evan Etter, Cordova, TN (US)

(21) Appl. No.: 15/398,677

(22) Filed: Jan. 4, 2017

Related U.S. Application Data
(60) Provisional application No. 62/274,673, filed on Jan. 4, 2016.

(51) Int. Cl. A23P 20/15; A47J 9/00; A23L 7/191

(52) U.S. Cl. CPC A23P 20/15; A23L 7/191; A47J 9/00; A23V 2002/00

(57) ABSTRACT

A device for the controlled delivery of a single service portion of buttered flavored toppings is disclosed. The device comprises a three ounce plastic vessel or bottle, wherein the bottle has a top that screws on to the bottle and wherein the top has a restricted nipple with a covering cap, wherein the nipple is configured to allow the user to apply the butter topping when desired. A method for the controlled delivery of single service portion of buttered flavored toppings is also disclosed.

A device and method to eliminate multiple complexities in the service of butter flavored topping to the movie goers and cinema owner is needed. A device and method that allows a single service application of butter flavored toppings to be added to popcorn, and/or other concession food service items, as desired by the purchaser/patron is needed. The single service application device and method allows the purchaser to apply as much or as little butter flavored topping to popcorn (or other food items) as desired. The individually packaged single service portions of butter flavored toppings allow for improved sanitation and protection from harmful cross contamination from other humans or aspects in the food service area. The single service application device also allows patrons to add additional butter flavored toppings throughout the consumption of the vessel/bucket of popcorn, for example, on top, in the middle and even at the end of the portion served.

Currently, cinema owners provide and portion butter flavoring toppings to their patrons by purchasing butter dispensers or equipment dispensers that cost thousands of dollars. The device and method for distributing a single service portion of butter flavored toppings would create a significant cost savings in equipment purchases for the cinema owners as the single service portion device would eliminate the expense for equipment as well as the expenses associated which such equipment including costs for maintenance, replacement parts, and warranties.

Additionally, the device and method for distributing a single service portion of butter flavored toppings would create a significant cost savings in other areas as well. The single service portion device prevents the cinema owner and staff from having to clean and maintain service areas floors accessible to its employees and/or patrons as currently butter flavored topping oil spills on floors and customer walkways create potentially harmful situations. The device would significantly decrease, if not eliminate altogether, the spills that create such potentially harmful areas on floors and walkways, and thus, fewer accidents in the work place and fewer accidents in the common areas would occur leading to lower insurance premiums and fewer complaints about spills.

Moreover, the device and method for distributing a single service portion of butter flavored toppings provides a more sanitary method of providing butter to popcorn and/or other concession food as each portion is sanitary and free from exposure to contamination such as to pests, insects and/or germs.

The device and method for distributing a single service portion of butter flavored toppings also allows the theater owner to control and manage the cost of the butter flavored toppings as every portion is the exact same amount, provided at the same cost. Thus, the device and method allows for the compensation for every portion served. Furthermore, the device and method disclosed herein allows the theater owners to accurately charge patrons for butter, extra butter, or other flavored toppings, which changes the operation efficiency from a cost to a revenue producer.

Additionally, the single service portion devices allows the theater owner to eliminate waste as the single service portion devices may be stored and used only when needed allowing fresh butter flavored toppings to be served as opposed to the current method used which involves purchasing butter flavored toppings in bulk volumes of 19-35 pound containers and using such bulk volumes on three ounce portions of popcorn until the container is empty. Such bulk containers lend themselves to the potential of containing old and outdated butter flavored topping.

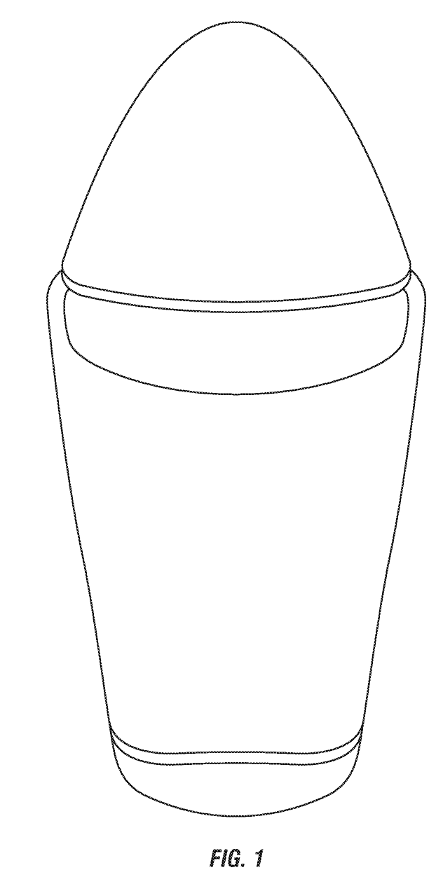

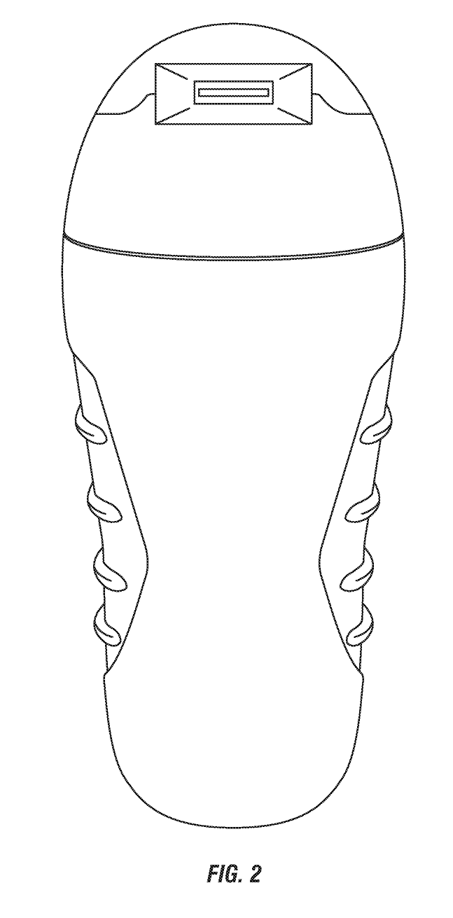

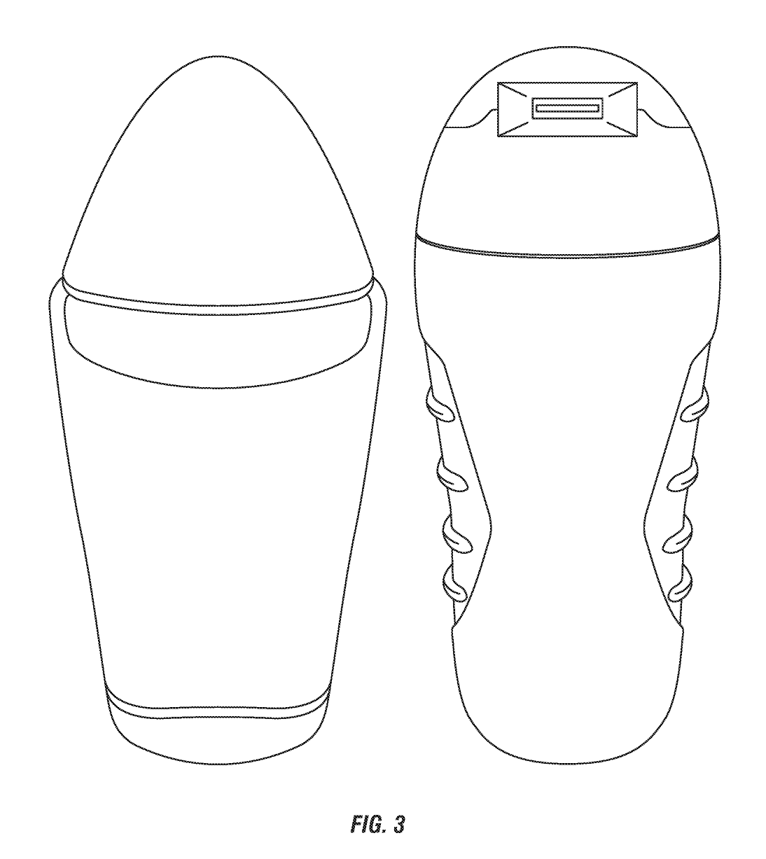

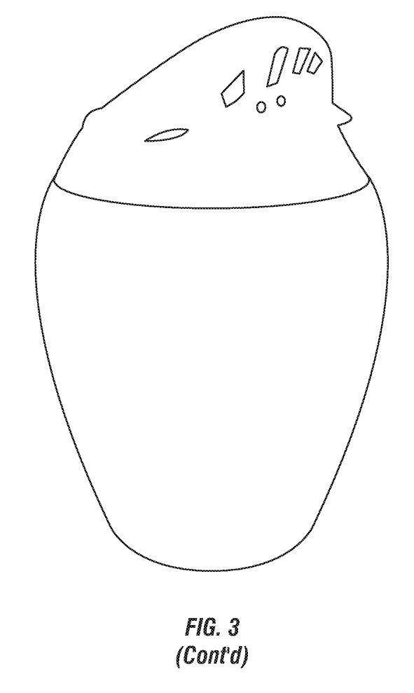

Referring to FIGS. 1 to 3, a device and method for the controlled delivery of a single service portion of butter flavored toppings for the movie owner and patrons is disclosed. In one embodiment, the device is a three ounce clear plastic vessel or bottle with a restricted nipple to allow the user to apply the butter topping as desired. In one embodiment, the vessel is made of clear or transparent plastic which allows the user to view the amount of liquid in the vessel and apply as desired. In other embodiments, the vessel may not be completely transparent but may be partially transparent in design as desired by one of skill in the art. The vessel may have be manufactured to have any level of transparency as long as the user is able to view the total amount of liquid inside the vessel at any given time.

In one embodiment, the dispensing vessel or bottle for controlled delivery of a liquid may be made of other flexible yet durable materials, similar to plastic, as desired by one of skill in the art. The flexible material of the vessel allows the liquid inside to be dispensed by pressure from the hand of the user. The dispensing vessel or bottle may be various shapes as desired by one of skill in the art.

In one embodiment, the vessel/bottle for the controlled delivery of a liquid buttered flavored topping has a top that screw onto the bottle. The screw on top includes a restricted nipple with covering cap. In one embodiment, the restricted nipple is leak proof and allows the butter flavored topping to be easily dispensed from the vessel/bottle by pressure from the user's hand on the vessel. The device and method disclosed allows patrons to use as much or as little butter topping as desired individually.

In one embodiment, the vessel for the controlled delivery of a liquid butter flavored topping contains a liquid form of oil rather than actual butter. In one example embodiment, the liquid is a combination of soy oils with flavoring. The soy oils are advantageous because such oils do not solidify, have an extensive shelf life of over one year, and do not require refrigeration or heating. Butter is typically not used because, as a dairy product, butter has a limited shelf life and additionally must be kept at certain temperatures to avoid risk of contamination and bacteria growth. In one embodiment, the butter flavored toppings are trans-fat free.

Flavorings, in dry and salted forms, may be combined with the butter flavored liquid to create numerous options of flavored butter topping to be offered to consumers. Such flavorings may include, but are not limited to, butter, sweet kettle corn, jalapeno, cool ranch, white cheddar cheese, caramel and nacho cheese. Any other flavorings may be combined with the butter flavored liquid as desired by one of skill in the art. Such combination of flavorings and liquid butter topping alleviates the need to apply two or more separate seasonings, such as butter and salt, to the food item.

In one embodiment, the users may use the device to apply a single serving portion of butter flavored liquid topping to any food item. In one embodiment, the single serving butter flavored liquid topping may be applied in multiple portion controlled segments to popcorn at a movie theater. In another embodiment, butter flavored liquid toppings may be applied in portion controlled segments to other food items such as soft pretzels, pastries, pizza, hot dogs, and/or any baked goods.

As set forth above, the device and method for the controlled delivery of a single service portion of a butter flavored toppings provides numerous cost savings to the theater owner including costs related to equipment cost, controlled cost on portioning and cost of goods, reduced insurance rates and costs related to providing cleaner more sanitary environments in the work place. The device and method for controlled delivery of a single service portion of a butter flavored topping allows improved service times and at any concession service counter where every patron is desirous of expedient service.

Currently, in the popcorn service industry, when a patron orders popcorn, the server will ask the patron if he or she would like butter on his or her popcorn. If the response is yes, then the server will ask the patron how much butter he or she would like. The patron may ask for a lot of butter, for a little amount of butter or for a regular amount of butter, all of which are undefined amounts of butter, and thus, the amount of butter ultimately dispensed onto the popcorn is highly subjective and dependent on the past experiences and/or training of the server.

Additionally, the patron may request that butter be evenly layered on to his/her popcorn. Such request involves the employee putting one layer of popcorn into the popcorn bucket or bag and then adding a first layer of butter, followed by adding a second layer of popcorn into the popcorn bucket or bag and adding a second layer of butter, and repeating this process until the bucket/bag is full. This process is time consuming causing inefficient service to the movie theater patrons. By handing the patron a single serving, three ounce portion of butter flavoring in a leak proof plastic bottle, the patron can easily traverse through the lobby without spills, locate a seat in the theater and then apply as much or as little of the butter flavoring as desired. The patron may apply more butter flavoring liquid at any time during the consumption achieving the “evenly layered” butter dispersion option. The device and method disclosed herein also allows each patron to have access to butter topping throughout the duration of the movie or other activity and to avoid having to return to the concession stand to request more butter topping.

In one embodiment, the device and method allows controlled delivery of a food substance that allows its users a choice of how much or how little should be applied to their taste. The user of the device does not have to rely on another person to randomly guess how much food substance (such as butter flavoring) to apply to the food/popcorn.

A method of use is disclosed herein. The method for distributing a single service portion of butter flavored toppings comprises the following steps: (a) obtaining a single service portion device of butter flavored topping, wherein the device (or vessel) has a structure described above; (b) obtaining a bucket/bag of popcorn or other food substance; (c) applying butter flavored topping in the amount desired to the popcorn exposed at the top of the bucket by applying pressure to the sides of the device; (d) eating the popcorn or food substance exposed at the top of such bucket and (e) continuing to apply additional butter flavored topping in the amount as desired to any layer of popcorn under the top layer as such layer becomes exposed and eating such popcorn.

The description and illustrations are by way of example only. While the description above makes reference to various embodiments, it should be understood that many changes and modifications may be made without departing from the scope of the disclosure. Many more embodiments and implementations are possible within the scope of this invention and will be apparent to those of ordinary skill in the art. The invention is not limited to the specific details, representative embodiments, and illustrated examples in the description.

I claim:

1. A method for distributing a single service portion of butter flavored toppings, the method comprising the following steps: (a) obtaining a single service portion device of butter flavored topping, wherein the device (or vessel) has a structure described above; (b) obtaining a bucket/bag of popcorn or other food substance; (c) applying butter flavored topping in the amount desired to the popcorn exposed at the top of the bucket by applying pressure to the sides of the device; (d) eating the popcorn or food substance exposed at the top of such bucket and (e) continuing to apply additional butter flavored topping in the amount as desired to any layer of popcorn under the top layer as such layer becomes exposed and eating such popcorn.

2. A device for the controlled delivery of a single service portion of buttered flavored toppings comprising a three ounce plastic vessel or bottle, wherein the bottle has a top that screws on to the bottle and wherein the top has a restricted nipple with a covering cap, wherein the nipple is configured to allow the user to apply the butter topping when desired.
